(19) United States
(12) Patent Application Publication
(10) Pub. No.: US 2016/0162755 A1
(43) Pub. Date: Jun. 9, 2016

(54) IMAGE PROCESSING APPARATUS AND IMAGE PROCESSING METHOD

(71) Applicant: CANON KABUSHIKI KAISHA, Tokyo (JP)

(72) Inventor: Kentaro Nagai, Yokohama-shi (JP)

(21) Appl. No.: 14/951,819

(22) Filed: Nov. 25, 2015

(30) Foreign Application Priority Data
Dec. 3, 2014 (JP) 2014-245118

(51) Int. Cl. G06K 9/62; G01B 11/25; G06T 7/00; G01B 9/02; G06K 9/32; G06K 9/74

(52) U.S. Cl. CPC G06K 9/62; G06K 9/3233; G06K 9/745; G06T 7/0002; G01B 9/02041; G01B 11/254; G06K 2009/3225; G06T 2207/10116

(57) ABSTRACT

An image processing apparatus configured to acquire an image having phase information of an electromagnetic wave from a cyclic pattern image generated by interference of the electromagnetic wave, comprises an acquisition unit configured to acquire a pattern image; a first conversion unit configured to convert the pattern image into a spectrum in a wave number space; a filter unit configured to apply to the spectrum a filter that cuts off components included in a predetermined cut-off region; and a second conversion unit configured to convert the filtered spectrum, in which the components included in the predetermined cut-off region are cut off, into an image having phase information, wherein the cut-off region is a region that includes at least a part of a first axis, which is an axis passing through a center point of the spectrum.

### BACKGROUND OF THE INVENTION

1. Field of the Invention

The present invention relates to an image processing apparatus that acquires phase information from a pattern image.

2. Description of the Related Art

One example of a method of accurately measuring a shape of a substance is a method of detecting a shift of phases which is generated by interference of an electromagnetic wave. In a measurement method using phases, the object is irradiated with light having uniform wave fronts (that is, coherent light) and interference is generated. Interference fringes generated in this manner include information on the change of a wave front (change of phase) of the incident light caused by a phase difference which is several times or several tens of times smaller than the wavelength, hence the change of the phase can be acquired by measuring the interference fringes. An apparatus that performs measurement using this method is called a “phase interferometer”, and can perform measurement at high precision allowing measurement of subtle unevenness on the surface of a lens, for example.

Among measurement methods that use interference, the X-ray phase imaging in particular is receiving attention lately. In the X-ray phase imaging, the change of the optical path length, which is generated when an X-ray is transmitted through an object, is detected through the interference in the phase and is imaged.

An example of the X-ray phase imaging is a Talbot interferometer using an X-ray. When an X-ray radiated from an X-ray source is transmitted through an object, the phase of this X-ray changes. Further, when the X-ray transmitted through the object passes through a grating having a cyclic pattern (diffraction grating), an interference pattern is generated at a position that is distant by a predetermined distance (Talbot distance). The X-ray Talbot interferometer measures the above mentioned change of the wave front of the incident light by analyzing the change of this interference pattern (hereafter called “first interference pattern”) depending on whether an object is present or not.

The pattern cycle of a diffraction grating is determined by the length of the apparatus and the wavelength of the incident light, and if the incident light is an X-ray, the pattern cycle normally is in a several μm order. Therefore the interference fringes generated by the diffraction grating also have a cycle in a several μm order, which cannot be detected by a resolution of a standard X-ray detector. Hence a masking grating having a same or similar cycle as the first interference pattern is disposed at a position where the first interference pattern is generated, so as to mask a part of the first interference pattern. Thereby a second interference pattern (moire) of which the cycle is about several hundred μm is generated. By detecting this moire using the X-ray detector, the change of the first interference pattern can be indirectly measured.

There are two methods of generating moire: a method of disposing a masking grating, the cycle of which is adjusted, in a same direction as the first interference pattern; and a method of disposing a masking grating in a rotated state. The moire generated by the former method is called “magnified moire”, and moire generated by the latter method is called “rotated moire”.

One method of acquiring information on an object by detecting moire is the above mentioned method of detecting the difference of optical path length of the incident light by using the change of the phase. By this method, the refractive index of the object can be acquired.

An advantage of the X-ray phase imaging, which, unlike the prior art, does not image the absorptivity of the X-ray inside the object, is that the exposure dose of a living body as the object can be kept low. Furthermore, a high S/N ratio can be acquired when the object is soft tissue or plastic.

An example of a method of acquiring a phase based on an interference pattern acquired by a phase interferometer (phase retrieval method) is a fringe scanning method. In the fringe scanning method, a plurality of images of moire is captured while changing conditions so that the phase changes, and X-ray absorptivity, refractive index or the like of the object is calculated based on the change amount of the measured values.

Meanwhile, the fringe scanning method requires a sub-micron order of precise positional control for the grating.

However, the precision of the grating is limited in an actual apparatus, because of such disturbance factors as the limits of mechanical precision, external vibration and drift of grating. Therefore, in some cases, an error is superimposed on the calculated differential phase as noise, and an artifact may be generated in the output image.

A method of correcting a drop in the precision of measurement due to a positional shift of the grating is disclosed in Japanese Patent Application Laid-Open No. 2014-121614. According to this method, the phase shift of moire caused by the positional shift of the grating can be calculated, whereby the positional shift of the grating, which is generated in micron units, can be corrected.

### SUMMARY OF THE INVENTION

The present invention in its one aspect provides an image processing apparatus configured to acquire an image having phase information of an electromagnetic wave from a cyclic pattern image generated by interference of the electromagnetic wave, comprises an acquisition unit configured to acquire a pattern image; a first conversion unit configured to convert the pattern image into a spectrum in a wave number space; a filter unit configured to apply to the spectrum a filter that cuts off components included in a predetermined cut-off region; and a second conversion unit configured to convert the filtered spectrum, in which the components included in the predetermined cut-off region are cut off, into an image having phase information, wherein the cut-off region is a region that includes at least a part of a first axis, which is an axis passing through a center point of the spectrum.

By the image processing apparatus according to one aspect of the present invention, generation of an artifact due to noise can be reduced in an image processing apparatus that acquires phase information based on a pattern image.

Further features of the present invention will become apparent from the following description of exemplary embodiments with reference to the attached drawings.

### BRIEF DESCRIPTION OF THE DRAWINGS

FIG. 1 is a schematic diagram depicting the imaging apparatus according to Embodiment 1;

FIGS. 2A to 2C show examples of an object and fringe patterns;

FIGS. 3A and 3B show the result when phase retrieval is performed using a prior art;

FIGS. 4A to 4C show the filter and phase retrieval result according to Embodiment 1;

FIG. 5 is a flow chart depicting the processing of the imaging apparatus according to Embodiment 1;

FIGS. 6A and 6B show modifications of the filter according to Embodiment 1; and

FIGS. 7A to 7C show the filter and phase retrieval result according to Embodiment 2.

### DESCRIPTION OF THE EMBODIMENTS

Embodiments of the present invention will now be described with reference to the drawings. The numeric values, materials, shapes, positions and the like used for the description of the embodiments should be changed, as appropriate, depending on the configuration of the apparatus to which the present invention is applied and various other conditions, and are not intended to limit the scope of the invention.

In the case of the method disclosed in Japanese Patent Application Laid-Open No. 2014-121614, an ideal model function on the shape of moire is defined, and the phase shift is corrected using this model function. However, if the actual imaged moire is different from one estimated by the model function, an error generated by this difference becomes noise that is superimposed on the recovered image.

With this problem of the prior art in view, embodiments of the present invention to be described hereinbelow provide a technique to reduce the generation of artifacts caused by noise in an image processing apparatus that acquires phase information based on a pattern image.

### Embodiment 1

<System Configuration>

An embodiment of the present invention will be described hereinbelow in detail with reference to the drawings.

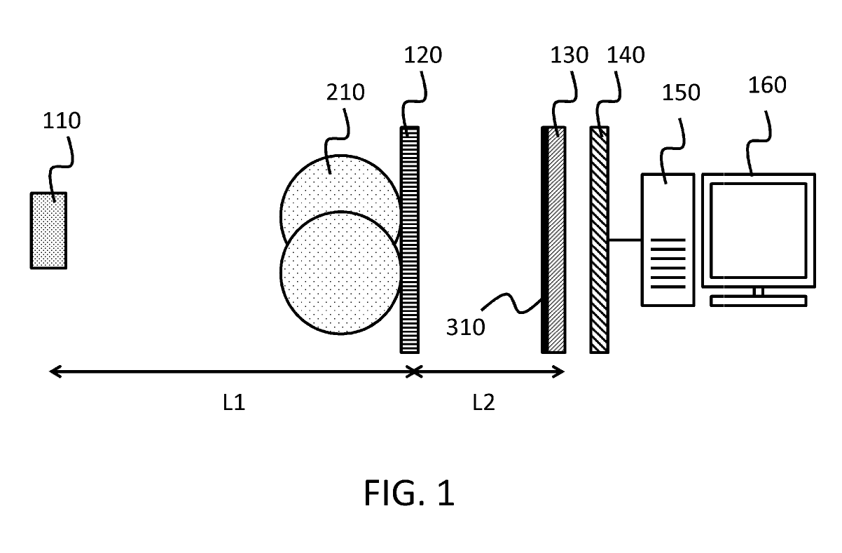

FIG. 1 is a diagram depicting a configuration of an imaging apparatus 1 according to this embodiment. The imaging apparatus 1 is a Talbot X-ray phase imaging apparatus, and includes an X-ray source 110, a diffraction grating 120, a masking grating 130, an X-ray detector 140, a computing unit 150 and an image display apparatus 160.

An object 210 (measurement target) is disposed between the X-ray source 110 and the diffraction grating 120 in this embodiment, but may be disposed between the diffraction grating 120 and the masking grating 130.

The X-ray source 110 is a radiation source which generates the X-ray with which the object 210 is to be irradiated. The radiated X-ray is transmitted through the object, then enters the diffraction grating 120.

The diffraction grating 120 is a unit that diffracts the X-ray transmitted through the object, and is a phase type diffraction grating where a grating pattern is disposed at a predetermined cycle. Instead of the phase type diffraction grating, an amplitude type diffraction grating may be used. The X-ray diffracted by the diffraction grating 120 forms a pattern image (interference image 310), in which light portions and dark portions are lined in the arrow direction at a predetermined distance called “Talbot distance”. In FIG. 1, the reference symbol L2 denotes the Talbot distance.

Hereafter the interference image generated by the diffraction grating 120 is called a “first interference pattern”.

The cycle of the first interference pattern generated by the interference of an X-ray is normally several μm to several tens of μm, and cannot be detected by a detector directly. Therefore the masking grating 130, the cycle of which is the same as or slightly different from the first interference pattern, is disposed at the Talbot distance so that a second interference pattern is generated. The masking grating 130 is a masking grating configured to mask a part of the X-ray by transparent portions and opaque portions which are array alternately. Thereby moire is generated, and the cycle of the first interference pattern can be magnified to at least several tens of μm (or to infinity).

The generated second interference pattern is detected by the X-ray detector 140. The X-ray detector 140 is a unit configured to acquire the X-ray intensity distribution on a plane (detection surface). The resolution of the X-ray detector is normally several tens of μm², but can indirectly measure the first interference pattern by generating moire.

The cycle of the second interference pattern can be determined considering the phase retrieval method to be used and the size of the detection surface of the X-ray detector 140, but in this embodiment, it is preferable to use a cycle that is double the pixel size or more and within the range of the detection surface of the X-ray detector 140.

The method of generating the second interference pattern may be a method of using the magnified moire or a method of using the rotated moire.

Now the relationship between the interference pattern and internal information of an object will be described.

In this embodiment, an object 210 is disposed midway between the X-ray source 110 and the diffraction grating 120. The X-ray normally has high transmissivity, hence if an object such as a living body is irradiated with the X-ray, most of the X-ray is transmitted through the object, and at this time the phase of the X-ray changes according to the elemental composition and density of the substance through which the X-ray was been transmitted.

This change of the phase influences the disposition of the first interference pattern. As a result, the second interference pattern, which is generated by the masking grating 130, is also distorted.

In this embodiment, the computing unit 150 acquires an image having the phase information (feature image) by recovering this distortion. Then the computing unit 150 acquires the internal information of the object by comparing this image with an image acquired when the object is absent. The acquired internal information is output to the image display apparatus 160 as image information.

In this embodiment, the computing unit 150 is implemented by a computer, but the computing function may be implemented by an FPGA, ASIC or the like, or may be implemented by a combination thereof.

<Phase Image Acquisition Method>

A conventional method of recovering a differential phase image from an acquired second interference pattern will be described next. The interference pattern generated by the grating (second interference pattern) is hereafter called “fringe pattern”.

Here a fringe scanning method will be described as a method of recovering the differential phase image using a Talbot interferometer. In this example, an example of generating a fringe pattern using a grating arrayed in two-dimensional directions will also be described. By this method, differential phase images in two directions (X axis direction and Y axis direction) can be acquired by one X-ray irradiation operation.

In the fringe scanning method, a plurality of fringe patterns iⁿ (x, y) is acquired while changing the relative positions of the diffraction grating 120 and the masking grating 130, and the complex phase information Bₓ (x, y) is determined using Expression (1).

$$\begin{matrix}[ Math . 1 ] & \\ {B}_{x} ( x , y ) = {\sum }_{n = 1}^{N} {i}^{n} ( x , y ) exp [ i ( {r}_{xx}^{n} + {r}_{xy}^{n} ) ] & Expression ( 1 )\end{matrix}$$

Here rⁿₓₓ and rⁿ_{xy} are complex constants, and are constants to express a phase of a fringe at each pixel that is determined by the relative positions of the diffraction grating 120 and the masking grating 130. Expression (1) expresses the differential information on the X axis direction, but the differential information on the Y axis direction can also be determined by B_{y} (x, y) using a similar expression.

After the complex phase information (Bₓ(x,y) and B_{y}(x,y)) is acquired, the respective argument is determined using Expression (2) and Expression (3). Thereby the differential phase Pₓ in the X axis direction and the differential phase P_{y} in the Y axis direction can be determined. Arg denotes an argument of a complex number.

Further, the integral phase image can be acquired by performing an integration operation using the acquired differential phase images.

[Math. 2]

Arg[Bₓ(x, y)] Expression (2)

Arg[B_{y}(x, y)] Expression (3)

Now the noise reduction technique according to a conventional method will be described. Japanese Patent Application Laid-Open No. 2014-121614 proposes an algorithm to determine each numeric value, including rⁿₓₓ and rⁿ_{xy} in Expression (1) using a self-consistent method. In this algorithm, the model function of moire is assumed as expressed in Expression (4).

Here a(x, y) is a variable that indicates information on an X-ray-absorbed image, and bₓ(x, y) and b_{y}(x, y) are variables that indicate the amplitudes of moire.

[Math. 3]

I(x, y)=a(x, y)(1+bₓ(x, y)cos(ωₓPₓ(x, y))(1+b_{y}(x, y)cos(ω_{y}+P_{y}(x, y))) Expression (4)

According to this method, noise superimposed on the generated integral phase image can be reduced.

A model function is used here, however this is merely for expressing an ideal moire, and in an actual case, moire having different shapes may be generated depending on the shape of the grating, the configuration of the apparatus, etc.

An actual example of recovering the phase using this method will be described next. This example shows a simulation result, but the result will be similar even when an image is acquired using an actual apparatus.

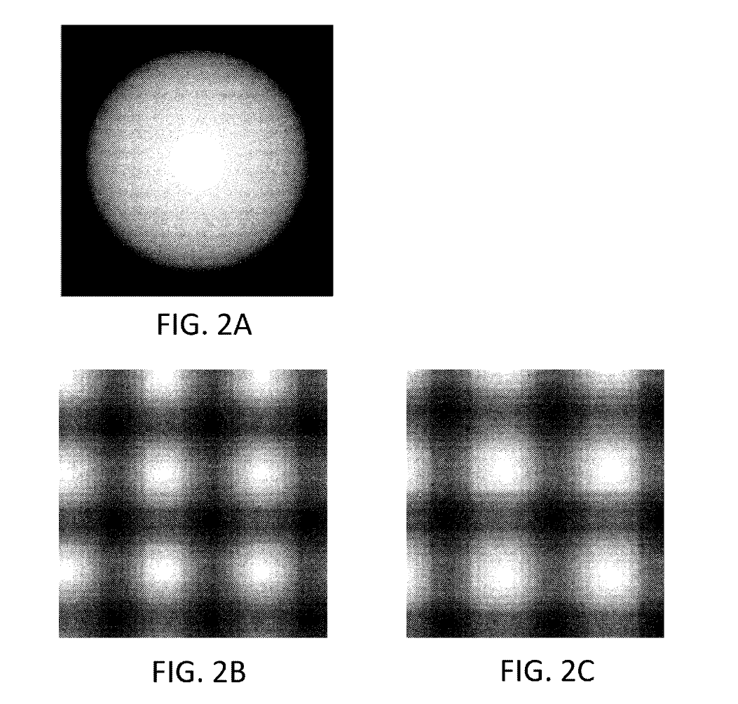

FIGS. 2A to 2C show a measurement target object and detected moire. FIG. 2A is a phase image of the object to be used. In this example, a spherical soft material is used as the object. This soft material is a suitable object for actual X-ray phase imaging, since the X-ray absorptivity is low and the refractive index is high. An image that is actually acquired by the X-ray phase imaging is a differential phase image.

FIG. 2B shows an example of a moire image acquired by imaging this object. This moire image presents an ideal moire as expressed by Expression (4). FIG. 2C shows a moire image when an error is generated due to the positional shift of the grating. The moire image shown in FIG. 2C cannot be expressed by a trigonometric function as Expression (4), but has a shape close to a sawtooth wave, and is asymmetrical with respect to the average. In other words, a higher order term is generated when Taylor expansion is performed.

With an actual interferometer, the processed shape of a standard grating normally includes an error, as shown in FIG. 2C, and it is rare that a moire image can be precisely expressed by an trigonometric function, as shown in FIG. 2B.

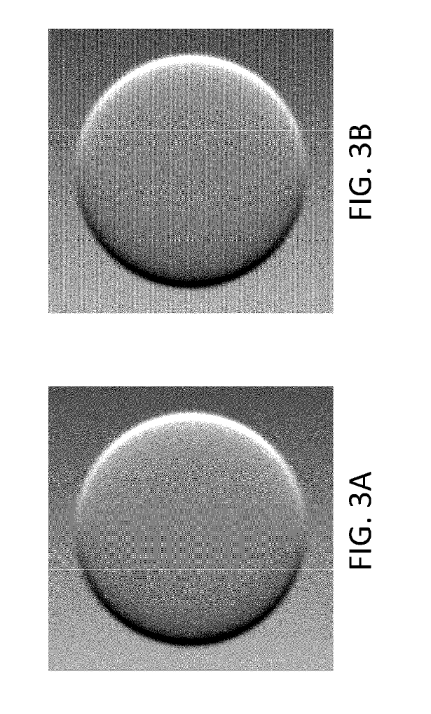

FIGS. 3A and 3B show the result when phase retrieval is performed on the respective moire images. When a fringe pattern is generated using a two-dimensionally arrayed grating, both a differential phase image in the X axis direction and a differential phase image in the Y axis direction can be acquired, but here only the differential phase image in the X axis direction will be described. Needless to say, this description is applicable to the differential phase image in the Y axis direction.

FIG. 3A is an example when the phase retrieval is performed using the moire image shown in FIG. 2B, and FIG. 3B is an example when the phase retrieval is performed using the moire image shown in FIG. 2C. As is clearly shown here, an artifact appears in the image in FIG. 3B. Due to the presence of such an artifact, quantitative problems occur in a differential phase image, or in an image generated by integrating a differential phase image.

<Filtering Method>

The filtering method performed by the computing unit 150 according to this embodiment will be described next. In this embodiment, the computing unit 150 acquires the differential phase information, and performs noise reduction processing according to the prior art, then converts this differential phase information back into an argument in the complex space, and performs Fourier transform. In concrete terms, the computing unit 150 performs computation of Expression (5) to the acquired differential phase Px. F denotes Fourier transform.

In the following description, the differential phase in the X axis direction will be described, but the similar method can be applied to the differential phase in the Y axis direction as well.

[Math. 4]

F[exp[iPₓ(x, y)]] Expression (5)

Fourier transform may be directly performed to the complex phase information using the method shown in Expression (6).

Here bₓ (x, y) is information on the moire amplitude in Expression (4), and can be acquired by calculating the absolute value of Bₓ in Expression (1). In other words, Expression (6) is equivalent to performing Fourier transform to Bₓ acquired by Expression (1). Thus it is also possible to directly perform the method of the present invention from the form of Expression (1), without determining the differential phase.

[Math. 5]

F[bₓ(x, y)exp[iPₓ(x, y)]]=F[Bₓ(x, y)] Expression (6)

The computing unit 150 according to this embodiment performs Fourier transform and acquires the spectrum in the wave number space, then applies a cut-off filter function generated by concentrating the cut-off region to an area near an axis that passes through the center point of the spectrum and is perpendicular to the differential direction. Hereafter the axis that passes through the center point of the spectrum in the wave number space is called “origin”, and an axis that passes through the origin and is perpendicular to the differential direction is called “first axis”. The spectrum in the wave number space has phase information, hence the spectrum in the wave number space may be called “phase spectrum” in the present invention and present description.

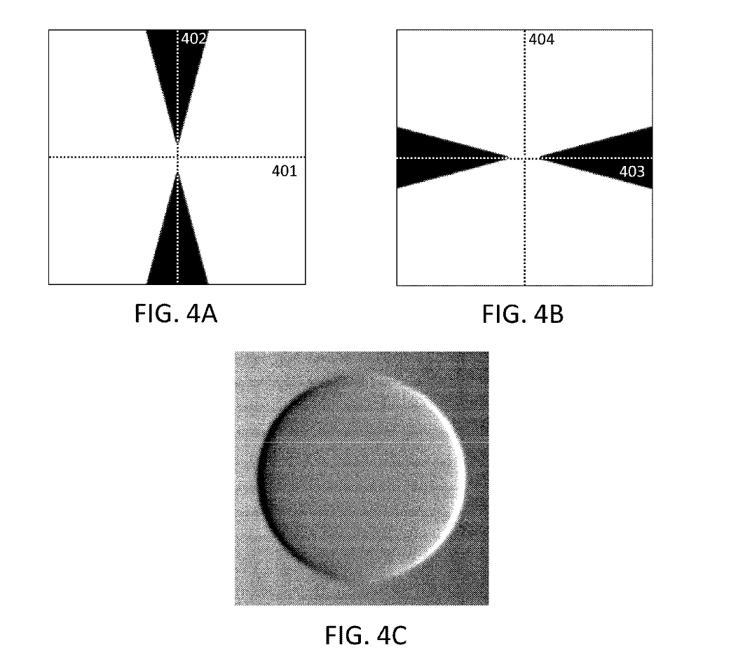

FIG. 4A shows a concrete shape of a filter. In the illustrated filter, the white portion indicates true values, and the black portion indicates false values. In other words, this filter uses only the white portion to pass, and the black portion to block. FIG. 4A is a filter that is applied to the differential phase information on the X axis direction, that is, a filter in which the cut-off region is disposed in a direction perpendicular to the X axis (disposed in the Y axis direction). FIG. 4B is an example of a filter that is applied to the differential phase information on the Y axis direction. The filter in this case is a filter in which the cut-off region is disposed in a direction perpendicular to the Y axis (disposed in the X axis direction).

The cut-off region is preferably a region that excludes the origin, and is more preferably a region that excludes (that is, that does not cut off) the origin and the vicinity regions thereof. For the vicinity of the origin, the smaller of the regions having half the moire cycle or less in the wave space (π/A or less if the moire cycle corresponds to A pixels) and π/10 or less should be selected.

The information on the differential phase in the wave number space exists along the axis that passes through the origin and is horizontal with respect to the differential direction (axis indicated by 401 or 404), and does not exist along the axis perpendicular to the differential direction (first axis indicated by 402 or 403). Therefore even if the information that exists in the vicinity of the first axis (excluding the area around the origin) is cut off, the quantitativity of the differential phase information is hardly diminished. By this method, noise components around the first axis can be effectively removed.

An image in which noise is removed can be acquired by performing filtering using the filter shown in FIGS. 4A and 4B, performing inverse Fourier transform to the filtered image (image after the components that exist in the cut-off region are removed), and acquiring the differential phase image.

FIG. 4C shows the differential phase image determined by performing the Fourier transform in Expression (5) to the differential phase image shown in FIG. 3B, and applying the filter shown in FIGS. 4A and 4B. It is clear that, compared with FIG. 3B, the artifact has disappeared.

<Processing Flow Chart>

A flow chart of processing for implementing the above described function will be described next.

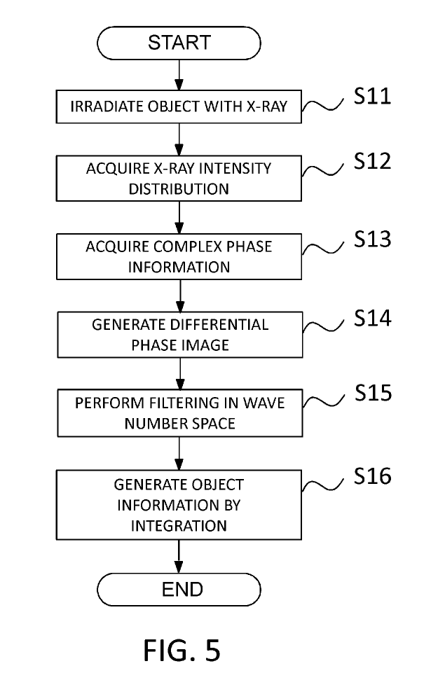

FIG. 5 is a flow chart depicting the processing performed by the imaging apparatus 1 according to this embodiment. This processing is started by user operation (e.g. imaging operation).

First in step S11, the X-ray source 110 generates an X-ray and the object 210 is irradiated with the X-ray. The radiated X-ray is transmitted through the object, is transmitted through the diffraction grating 120 and the masking grating 130, then enters the X-ray detector 140.

Then in step S12, the X-ray detector 140 acquires the X-ray intensity distribution on the detection surface. The acquired intensity distribution is transmitted to the computing unit 150.

Then in step S13, the computing unit 150 converts the acquired X-ray intensity distribution into complex phase information. Then in step S14, the computing unit 150 generates a differential phase image from the complex phase information. After step S14 is executed, arbitrary noise reduction processing, such as the method disclosed in Japanese Patent Application Laid-Open No. 2014-121614, may be executed.

In step S15, the computing unit 150 converts the differential phase image back to the complex phase information, and converts the complex phase information into the phase spectrum by Fourier transform. Then the computing unit 150 performs filtering in the wave number space by the above mentioned method, and reconstructs information by inverse Fourier transform, then generates the differential phase image again.

If another noise reduction processing is not performed to the differential phase image, step S14 may be omitted. In this case, Fourier transform can be directly performed to the complex phase information in step S15.

The processing in steps S13 to S15 are executed for the differential information on the X axis direction and the differential information on the Y axis direction respectively.

Finally in step S16, the computing unit 150 acquires an integral phase image (image representing the object information) by performing the integration operation using the respective differential phase images. The acquired integral phase image is image-processed and then output to the image display apparatus 160.

As described bone, the imaging apparatus according to Embodiment 1 reduces noise by generating the phase spectrum in each differential direction based on the acquired moire image and applying a filter corresponding to each differential direction. Thereby an artifact can be deleted from the image representing the object information.

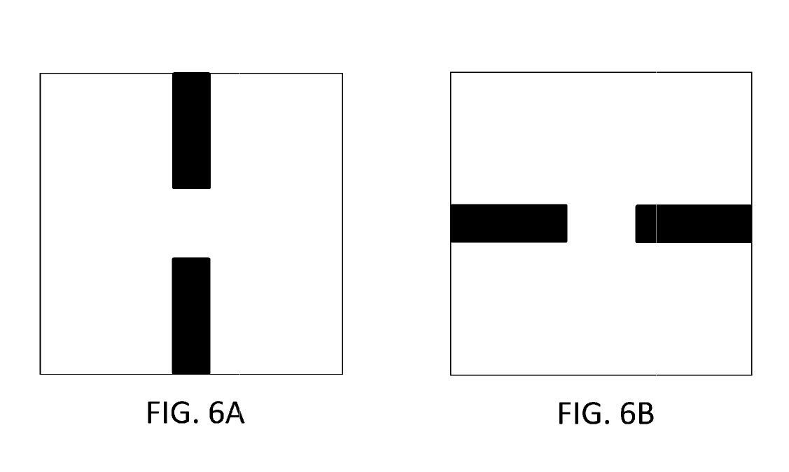

In Embodiment 1, a V-shaped filter, in which the distance from the first axis to the boundary of the cut-off region increases in proportion to the distance from the origin, is used, but the filter may have a rectangular shape, as shown in FIGS. 6A and 6B. A combination of these filters may also be used. The cut-off region may have any shape as long the region includes a part of the first axis or is located in the vicinity of the first axis and the noise reduction effect can be acquired by cutting off noise components.

### Embodiment 2

Compared with Embodiment 1, the shape of the filter is different in Embodiment 2. The system configuration and processing contents of the imaging apparatus according to Embodiment 2 are the same as Embodiment 1, hence detailed description thereof is omitted, and only the differences in the filter from Embodiment 1 will be described.

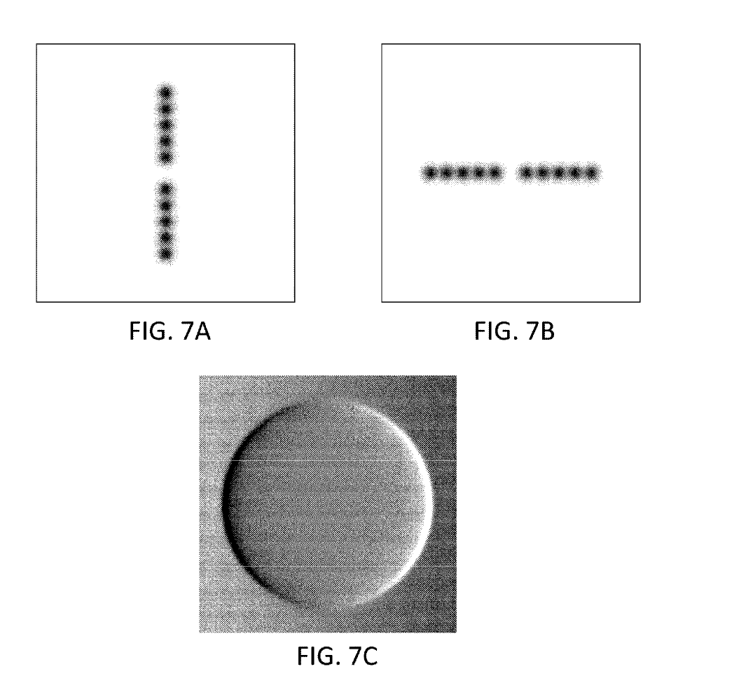

In Embodiment 2, a filter having a shape shown in FIGS. 7A and 7B is used as the filter used by the computing unit 150. The filter used in Embodiment 2 is constituted by a set of a plurality of closed regions. In the illustrated filters, the black portion indicates false values, and the white portion indicates true values, similarly to Embodiment 1. An intermediate color has a coefficient according to color.

In Embodiment 2, similarly to Embodiment 1, the filter is disposed on an axis that is perpendicular to the differential direction.

The above mentioned influence of the harmonics of the moire image appears in positions corresponding to an integer multiple of the cycle of the moire in the wave number space. Therefore it is preferable that the diameter of a small circle is about half the cycle of moire in this direction, and the center of the small circle is disposed at a position corresponding to an integer multiple of the cycle of the moire.

FIG. 7C shows a differential phase image acquired from the moire image shown in FIG. 2C by applying the filter shown in FIG. 7A to the differential phase information on the X axis direction, and applying the filter shown in FIG. 7B to the differential phase information on the Y axis direction. It is clear that, compared with FIG. 3B, the artifact has disappeared, similarly to Embodiment 1.

(Quantitativity Evaluation)

Table 1 is a result of comparing the errors of the prior art and each embodiment. The numeric values in Table 1 show the averages of the errors with respect to the true values of original data. In other words, each value is more accurate as the value is smaller, and if the value is smaller than the prior art, then the effect of the present invention is demonstrated.

In Table 1, not only the error of the differential phase but the error of the moire amplitude, which can be acquired by determining the absolute value of Expression (1), is also calculated and listed. The moire amplitude is expressed by bₓ or b_{y} in Expression (4). The moire amplitude in some cases includes information on a structure that is equal to or smaller than the pixel cycle of an object, and therefore the moire amplitude is one of the parameters that are currently receiving attention.

TABLE 1

| | Error of | Error of |
|---|---|---|
| | differential phase | moire amplitude |
| Prior art | 0.0587 | 0.0568 |
| Embodiment 1 | 0.0108 | 0.0094 |
| Embodiment 2 | 0.0151 | 0.0121 |

As Table 1 shows, compared with the prior art, both the errors of the differential phase and the moire amplitude have decreased and quantitativity has improved in each embodiment. This means that artifacts have been decreased qualitatively and quantitatively, and the accuracy of measurement has improved.

(Modification)

The description of the embodiments are only examples to explain the present invention, and the present invention can be carried out by modifying or combining the above embodiments within a scope not departing from the spirit of the invention. For example, the present invention may be carried out as an imaging apparatus that includes at least a part of the above mentioned various processing, or may be carried out as an image processing apparatus that does not includes a unit to detect an interference image (an interference image detection apparatus), and instead generates an integral phase image using an input interference image. Furthermore, the present invention may be carried out as an image processing method, or as a program that allows an image processing apparatus to execute this method. The above mentioned processing and units may be freely combined to carry out the invention as long as a technical inconsistency is not generated.

The imaging apparatus according to the present invention is not limited to an apparatus that images information on an object, as long as the apparatus images a cyclic pattern generated by interference. Further, the image processing apparatus according to the present invention may not be an apparatus that outputs an image, as long as the apparatus outputs information that is different from the input information using intensity information of cyclic patterns.

In the description of the embodiments, an example of the Talbot type X-ray phase imaging apparatus using two-dimensional grating was used, but the image processing method according to the present invention may be applied to a differential interferometer in any other format as long as the apparatus acquires the change of the phase caused by interference. For example, the image processing method may be applied to an apparatus configured to perform the X-ray phase imaging using one-dimensional grating. The electromagnetic wave used for measurement is not limited to an X-ray, but may have any wavelength.

The image processing apparatus according to the present invention particularly demonstrates its effect by applying the technique disclosed in Japanese Patent Application Laid-Open No. 2014-121614, but this technique is not essential.

The image processing apparatus according to the present invention may be applied to a phase retrieval method other than the fringe scanning method. For example, the present invention may be applied to the Fourier transform method or the like. In this case, a region having the differential phase information on a specific axis direction is extracted from the result of performing Fourier transform on a fringe pattern, and filtering is performed on this region using the above described method. The technique of the present invention can be applied as long as the phase spectrum of the object to be filtered has the differential phase information on a specific axis direction.

In the description of the embodiments, the processing is performed by acquiring the differential phase information on the X axis direction and the differential phase information on the Y axis direction respectively, but the processing may be performed by acquiring the differential phase information on any direction other than the above mentioned directions.

In the description of the embodiments, the components included in the cut-off region are removed, but the components included in the cut-off region need not always be completely removed. The effect of the present invention can be demonstrated even if some components remain. It is preferable to remove 80% or more of the components included in the cut-off region by filtering, but the present invention is not limited to this.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-245118, filed on Dec. 3, 2014, which is hereby incorporated by reference herein in its entirety.

What is claimed is:

1. An image processing apparatus configured to acquire an image having phase information of an electromagnetic wave from a cyclic pattern image generated by interference of the electromagnetic wave, comprising:
an acquisition unit configured to acquire a pattern image;
a first conversion unit configured to convert the pattern image into a spectrum in a wave number space;
a filter unit configured to apply to the spectrum a filter that cuts off components included in a predetermined cut-off region; and
a second conversion unit configured to convert the filtered spectrum, in which the components included in the predetermined cut-off region are cut off, into an image having phase information, wherein
the cut-off region is a region that includes at least a part of a first axis, which is an axis passing through a center point of the spectrum.

2. The image processing apparatus according to claim 1, wherein
the spectrum has differential phase information with respect to a predetermined direction, and
the first axis is an axis that exists in a direction perpendicular to the predetermined direction.

3. The image processing apparatus according to claim 1, wherein
the cut-off region does not include the center point of the spectrum and vicinity regions thereof.

4. The image processing apparatus according to claim 1, wherein
the cut-off region has a symmetrical shape with respect to a second axis, which is an axis that passes through the center point of the spectrum and exists in a predetermined direction.

5. The image processing apparatus according to claim 1, wherein
a distance from the first axis to a boundary of the cut-off region increases in proportion to a distance from the center point of the spectrum.

6. The image processing apparatus according to claim 1, wherein
the cut-off region is constituted by a plurality of closed regions, and a center point of each of the closed regions is a point of which a distance from the center point of the spectrum corresponds to an integer multiple of a cycle of the pattern image.

7. The image processing apparatus according to claim 1, wherein
the pattern image is an image generated by an interference image detection apparatus configured to detect, using a detector, an interference pattern formed by interference of an electromagnetic wave with which an object is irradiated.

8. An imaging apparatus, comprising:
a diffraction grating configured to diffract an electromagnetic wave with which an object is irradiated;
a masking grating configured to cyclically mask a part of the electromagnetic wave that passed through the diffraction grating;
a detector configured to detect, as a pattern image, an intensity distribution on a plane of the electromagnetic wave that passed through the masking grating; and
an image processing apparatus configured to acquire an image having phase information of the electromagnetic wave using the pattern image, wherein
the image processing apparatus includes:
a first conversion unit configured to convert the pattern image into a spectrum in a wave number space;
a filter unit configured to apply to the spectrum a filter that cuts off components included in a predetermined cut-off region; and
a second conversion unit configured to convert the filtered spectrum, in which the components included in the predetermined cut-off region are cut off, into an image having phase information, wherein
the cut-off region is a region that includes at least a part of a first axis, which is an axis passing through a center point of the spectrum.

9. An image processing method performed by an image processing apparatus which is configured to acquire an image having phase information of an electromagnetic wave from a cyclic pattern image generated by interference of the electromagnetic wave, comprising:
an acquisition step of acquiring a pattern image;
a first conversion step of converting the pattern image into a spectrum in a wave number space;
a filter step of applying to the spectrum a filter that cuts off components included in a predetermined cut-off region; and
a second conversion step of converting the filtered spectrum, in which the components included in the predetermined cut-off region are cut off, into an image having phase information, wherein
the cut-off region is a region that includes at least a part of a first axis, which is an axis passing through a center point of the spectrum.

10. The image processing method according to claim 9, wherein
the spectrum has differential phase information with respect to a predetermined direction, and
the first axis is an axis that exists in a direction perpendicular to the predetermined direction.

11. The image processing method according to claim 9, wherein
the cut-off region does not include the center point of the spectrum and vicinity regions thereof.

12. The image processing method according to claim 9, wherein
the cut-off region has a symmetrical shape with respect to a second axis, which is an axis that passes through the center point of the spectrum and exists in a predetermined direction.

13. The image processing method according to claim 9, wherein
a distance from the first axis to a boundary of the cut-off region increases in proportion to a distance from the center point of the spectrum.

14. The image processing method according to claim 9, wherein
the cut-off region is constituted by a plurality of closed regions, and a center point of each of the closed regions is a point of which a distance from the center point of the spectrum corresponds to an integer multiple of a cycle of the pattern image.

15. A non-transitory computer readable storing medium recording a computer program for causing a computer to perform a method comprising the steps of:
an acquisition step of acquiring a pattern image;
a first conversion step of converting the pattern image into a spectrum in a wave number space;
a filter step of applying to the spectrum a filter which cuts off components included in a predetermined cut-off region; and
a second conversion step of converting the filtered spectrum, in which the components included in the predetermined cut-off region are cut off, into an image having phase information, wherein
the cut-off region is a region that includes at least a part of a first axis, which is an axis passing through a center point of the spectrum.
